(19) United States
(12) Patent Application Publication
(10) Pub. No.: US 2017/0276198 A1
(43) Pub. Date: Sep. 28, 2017

(54) BRAKE PAD

(71) Applicant: Yu-Ping WANG, Xianxi Township (TW)

(72) Inventor: Yu-Ping WANG, Xianxi Township (TW)

(21) Appl. No.: 15/082,209

(22) Filed: Mar. 28, 2016

(51) Int. Cl. F16D 65/847; F16D 65/095

(52) U.S. Cl. CPC F16D 65/847; F16D 65/095

(57) ABSTRACT

A brake pad includes a main plate and a brake lining secured on one face of the main plate. A heat dissipation structure is formed on one side of the main plate opposite to the brake lining. The heat dissipation structure guides a backward airflow toward the main plate for promoting the heat dissipation effect of the lining during braking process or finishing braking process.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to brake pad, and more particularly to a brake pad that has a function of guiding airflow for promoting dissipation effect.

2. Description of Related Art Including Information Disclosed Under 37 CFR 1.97 and 37 CFR 1.98.

A bicycle is an important equipment for short-range movement. The bicycle becomes more and more popular in our daily life and every family due the features of environmental protection and leisure.

Bicycles are non-mainstream transportation, however a braking device is necessary just like any other mainstream transportation because the braking device is very important to road-traffic safety. Common braking devices are divided into two kinds including drum brake and disc brake. The two kinds of brake devices use a brake lining to rub the drum or disc for causing friction to speed down or stop. Generally, the braking effect of the disc brake is better than that of the drum brake. As a result, a high grade bicycle or a bicycle having special safety concerns usually uses the disc brake for promoting the additional value of the bicycles.

As described above, the disc brake uses the brake lining to rub the disc for continual causing friction and uses the continually raised friction to speed down or stop, and the most kinetic energy is transformed to heat energy. As a result, the friction coefficient and the brake effect are reduced due to a high temperature of the brake lining and the disc. In view of this, all brake manufacturers focus on the heat dissipation effect for promoting the road safety. Most of the brake manufacturers dispose heat dissipation fins or hollow stubs in the brake device for promoting the heat dissipation effect. However, the promoting range is always limited because they ignore the airflow and the windward.

The present invention has arisen to mitigate and/or obviate the disadvantages of the conventional brake devices.

### BRIEF SUMMARY OF THE INVENTION

The main objective of the present invention is to provide an improved brake pad that has a function of guiding airflow for promoting dissipation effect.

To achieve the objective, the brake pad in accordance with the present invention comprises a main plate having a first face and a second face and a brake lining secured on the first face of the main plate. A heat dissipation structure is formed on one side of the main plate opposite to the brake lining, wherein the heat dissipation structure guides a backward airflow toward the main plate for promoting the heat dissipation effect of the main plate and the lining during braking. The heat dissipation structure includes multiple first heat dissipation fins, multiple second heat dissipation fins and a guard respectively extending from one side of the main plate opposite to the brake lining, wherein the guard surrounds the multiple first heat dissipation fins and the multiple second heat dissipation fins for preventing the multiple first heat dissipation fins and the multiple second heat dissipation fins from being deformed and reducing the original brake effect due to an improper buffet. The multiple first heat dissipation fins and the multiple second heat dissipation fins are reversally and alternately arranged relative to each other for guiding a backward airflow to the main plate and the brake lining during moving.

Further benefits and advantages of the present invention will become apparent after a careful reading of the detailed description with appropriate reference to the accompanying drawings.

### BRIEF DESCRIPTION OF THE SEVERAL VIEWS OF THE DRAWINGS

FIG. 1 is a perspective view of a brake pad in accordance with the present invention.

FIG. 2 is a top plan view of the brake pad in FIG. 1.

FIG. 3 is a partially perspective view of the brake pad in accordance with the present invention.

FIG. 4 is a partially cross-sectional view of a second embodiment of the brake pad in accordance with the present invention.

FIG. 5 is a partially cross-sectional view of a third embodiment of the brake pad in accordance with the present invention.

FIG. 6 is a top operational view of the brake pad in accordance with the present invention when guiding airflow.

FIG. 7 is a partially cross-sectional view of a fourth embodiment of the brake pad in accordance with the present invention.

FIG. 8 is a partially cross-sectional view of a fifth embodiment of the brake pad in accordance with the present invention.

FIG. 9 is a partially cross-sectional view of a sixth embodiment of the brake pad in accordance with the present invention.

### DETAILED DESCRIPTION OF THE INVENTION

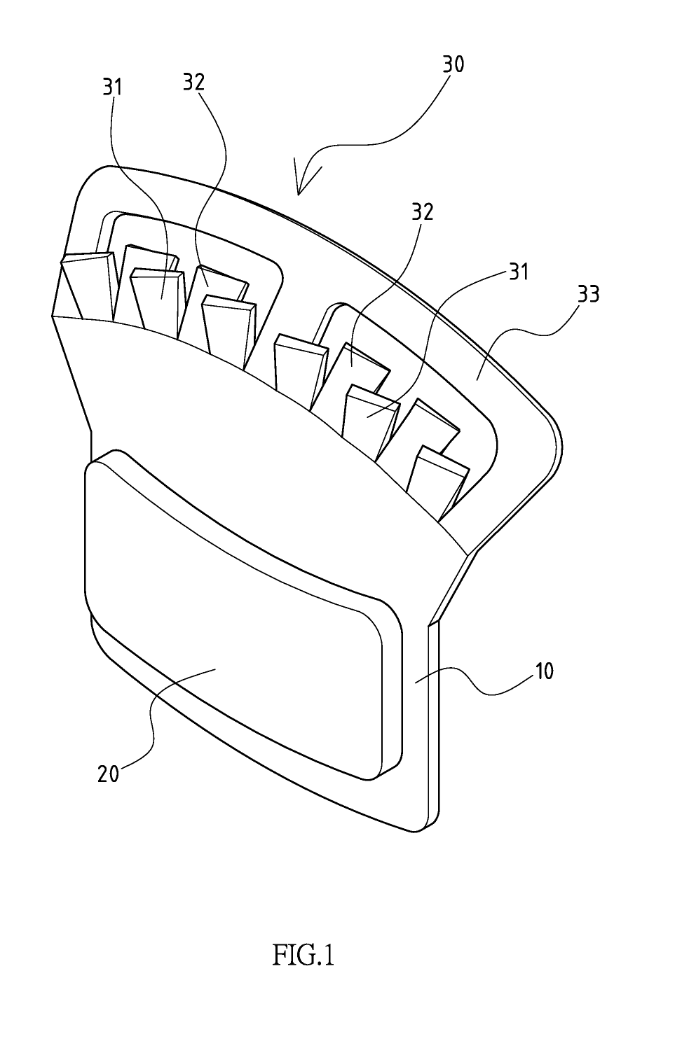

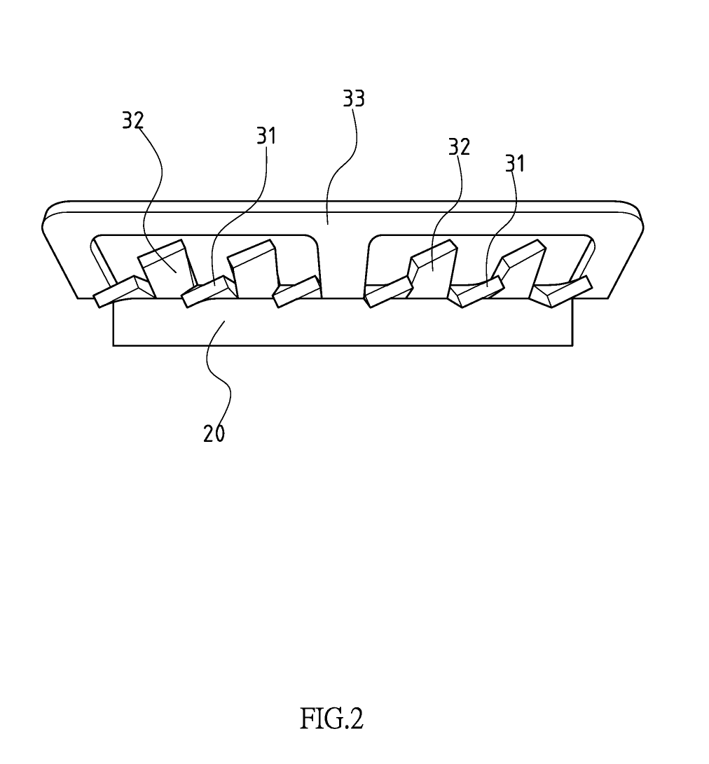

Referring to the drawings and initially to FIGS. 1 and 2, a brake pad in accordance with the present invention comprises a main plate 10 and a brake lining 20 secured on one face of the main plate 10. A heat dissipation structure 30 is formed on one side of the main plate 10 opposite to the brake lining 20, wherein the heat dissipation structure 30 guides a backward airflow toward the main plate 10 for promoting the heat dissipation effect of the main plate 10 and the lining 20 during braking process or finishing braking process.

The main plate 10 has a first face and a second face, wherein the brake lining 20 is secured on the first face of the main plate 10. The heat dissipation structure 30 includes multiple first heat dissipation fins 31, multiple second heat dissipation fins 32 and a guard 33 respectively extending from one side of the main plate 10 opposite to the brake lining 20. The guard 33 surrounds the multiple first heat dissipation fins 31 and the multiple second heat dissipation fins 32 for preventing the multiple first heat dissipation fins 31 and the multiple second heat dissipation fins 32 from being deformed and reducing the original brake effect due to an improper buffet. The multiple first heat dissipation fins 31 and the multiple second heat dissipation fins 32 are reversally and alternately arranged relative to each other. In the preferred embodiment of the present invention, the multiple first heat dissipation fins 31, the multiple second heat dissipation fins 32 and the guard 33 are integrally formed with the main plate 10.

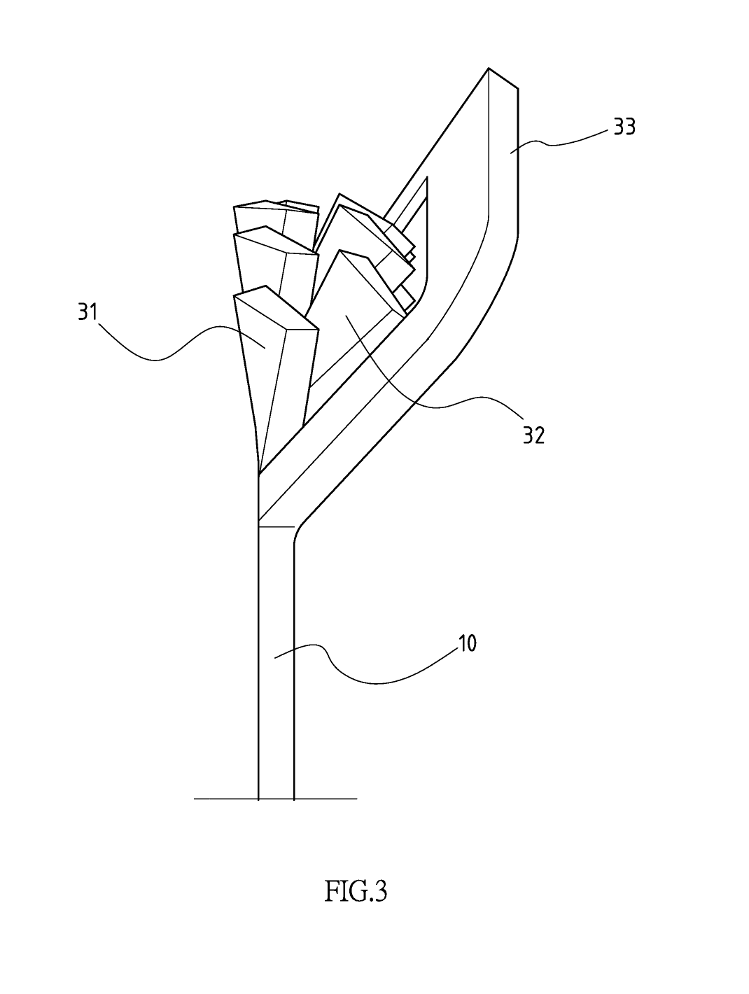

With reference to FIG. 3, each of the second heat dissipation fins 32 is bent toward the second face of the main plate 10. The multiple first heat dissipation fins 31 and the main plate 10 are arranged on a same plane, and the multiple second heat dissipation fins 32 and the guard 33 are arranged on a same plane.

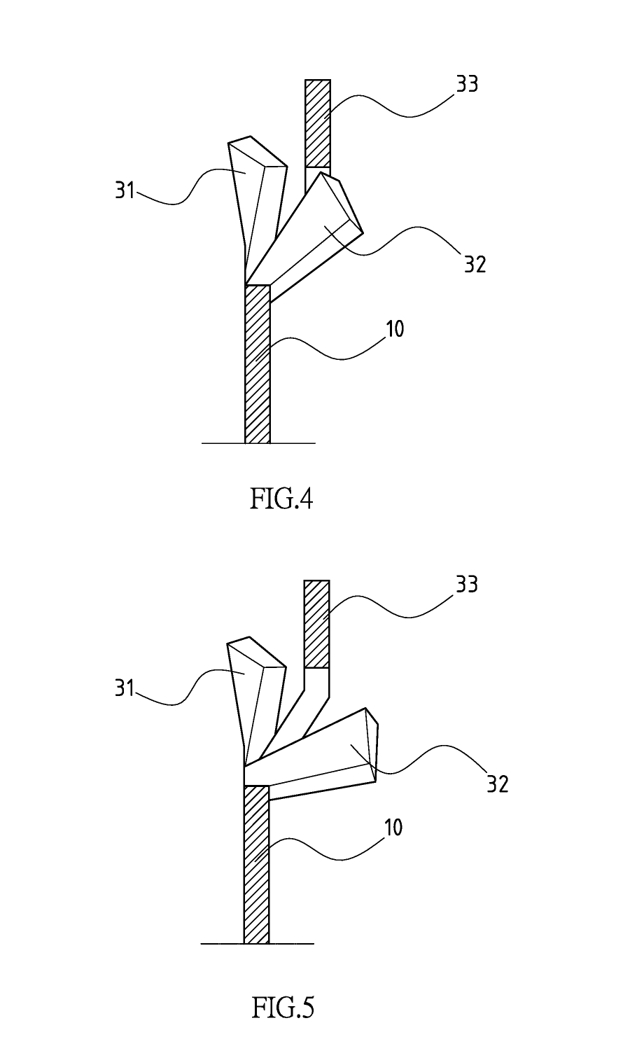

With reference to FIG. 4 that shows a second embodiment of the brake pad in accordance with the present invention, in this embodiment, the distal side of the guard 33 is bent and parallel to the main plate 10.

With reference to FIG. 5 that shows a third embodiment of the brake pad in accordance with the present invention, in this embodiment, the multiple first heat dissipation fins 31 and the main plate 10 are arranged on a same plane, and the guard 33 is arranged between the multiple first heat dissipation fins 31 and the multiple second heat dissipation fins 32.

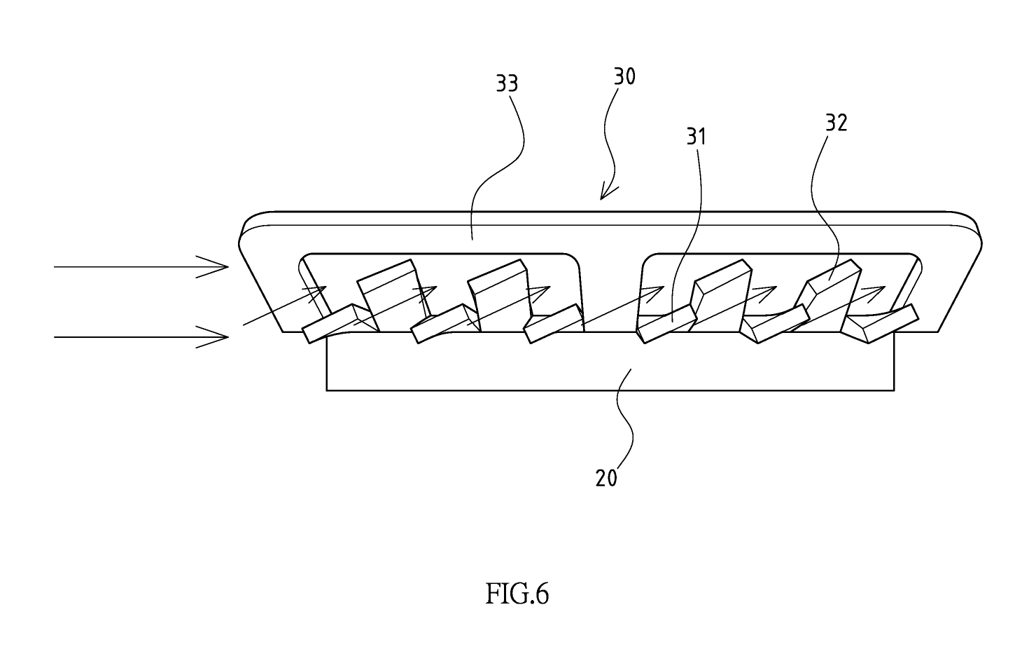

With reference to FIG. 6, each first heat dissipation fin 31 and each second heat dissipation fin 32 have a rear end relative to a moving direction. Each rear end of the multiple first heat dissipation fins 31 and multiple second heat dissipation fins 32 are inwardly bent toward main plate 10 for enlarged windward face of the multiple first heat dissipation fins 31 and multiple second heat dissipation fins 32. In addition, the bent multiple first heat dissipation fins 31 and multiple second heat dissipation fins 32 guide the backward airflow W to the main plate 10 and the brake lining 20 for promoting the heat dissipation effect of the brake pad in accordance with the present invention.

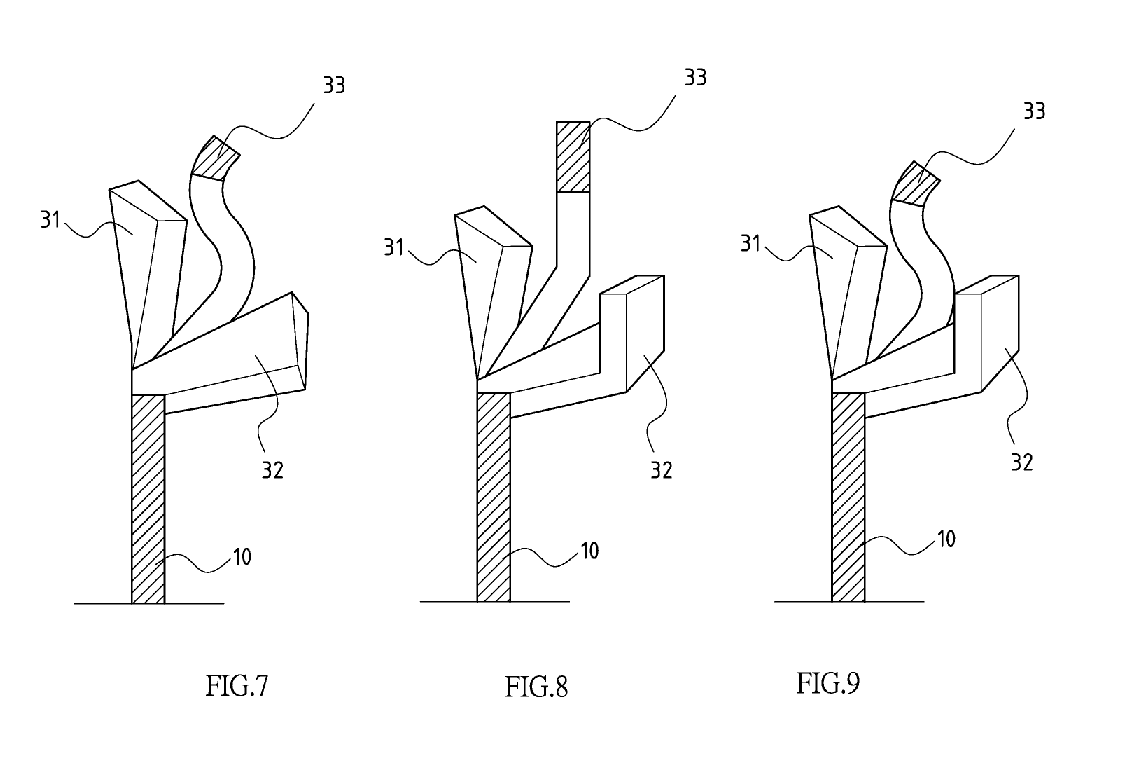

With reference to FIG. 7 that shows a fourth embodiment of the brake pad in accordance with the present invention, the guard 33 in the third embodiment has a continually wave-shaped cross-section.

With reference to FIG. 8 that shows a fifth embodiment of the brake pad in accordance with the present invention, a free end of each of the multiple second heat dissipation fins 32 in the third embodiment is bent and parallel to the main plate 10.

With reference to FIG. 9 that shows a sixth embodiment of the brake pad in accordance with the present invention, the guard 33 in the fifth embodiment has a continually wave-shaped cross-section.

As described above, each heat dissipation fin 31/32 is bent for enlarging a windward face thereof and guiding the backward airflow toward the main plate 10 and the brake lining 20. Consequently, the heat dissipation effect of the main plate 10 and the brake lining 20 is greatly promoted relative to the conventional brake pad in accordance with the prior art.

Although the invention has been explained in relation to its preferred embodiment, it is to be understood that many other possible modifications and variations can be made without departing from the spirit and scope of the invention as hereinafter claimed.

I claim:

1. A brake pad comprising a main plate having a first face and a second face, a brake lining secured on the first face of the main plate, a heat dissipation structure formed on one side of the main plate opposite to the brake lining, wherein the heat dissipation structure guides a backward airflow toward the main plate for promoting the heat dissipation effect of the main plate and the lining during braking, the heat dissipation structure including multiple first heat dissipation fins, multiple second heat dissipation fins and a guard respectively extending from one side of the main plate opposite to the brake lining, wherein the guard surrounds the multiple first heat dissipation fins and the multiple second heat dissipation fins for preventing the multiple first heat dissipation fins and the multiple second heat dissipation fins from being deformed and reducing the original brake effect due to an improper buffet, the multiple first heat dissipation fins and the multiple second heat dissipation fins reversally and alternately arranged relative to each other for guiding a backward airflow to the main plate and the brake lining during moving.

2. The brake pad as claimed in claim 1, wherein each first heat dissipation fin and each second heat dissipation fin have a rear end relative to a moving direction, each rear end of the multiple first heat dissipation fins and multiple second heat dissipation fins inwardly bent toward main plate for enlarged windward face of the multiple first heat dissipation fins and multiple second heat dissipation fins, the bent multiple first heat dissipation fins and multiple second heat dissipation fins guiding the backward airflow to the main plate and the brake lining for promoting the heat dissipation effect.

3. The brake pad as claimed in claim 1, wherein the multiple second heat dissipation fins are bent toward the second face of the main plate, the multiple first heat dissipation fins and the main plate are arranged on a same plane, and the guard and the multiple heat dissipation fins are arranged on a same plane.

4. The brake pad as claimed in claim 2, wherein the multiple second heat dissipation fins are bent toward the second face of the main plate, the multiple first heat dissipation fins and the main plate are arranged on a same plane, and the guard and the multiple heat dissipation fins are arranged on a same plane.

5. The brake pad as claimed in claim 1, wherein the multiple second heat dissipation fins are bent toward the second face of the main plate, the multiple first heat dissipation fins and the main plate are arranged on a same plane, and the guard is arranged between the multiple first heat dissipation fins and the multiple heat dissipation fins.

6. The brake pad as claimed in claim 2, wherein the multiple second heat dissipation fins are bent toward the second face of the main plate, the multiple first heat dissipation fins and the main plate are arranged on a same plane, and the guard is arranged between the multiple first heat dissipation fins and the multiple heat dissipation fins.

7. The brake pad as claimed in claim 3, wherein the guard has a distal side parallel to the main plate after being bent.

8. The brake pad as claimed in claim 4, wherein the guard has a distal side parallel to the main plate after being bent.

9. The brake pad as claimed in claim 5, wherein the guard has a distal side parallel to the main plate after being bent.

10. The brake pad as claimed in claim 6, wherein the guard has a distal side parallel to the main plate after being bent.

11. The brake pad as claimed in claim 5, wherein each second heat dissipation fin has free end parallel to the main plate after being bent.

12. The brake pad as claimed in claim 6, wherein each second heat dissipation fin has free end parallel to the main plate after being bent.

13. The brake pad as claimed in claim 7, wherein each second heat dissipation fin has free end parallel to the main plate after being bent.

14. The brake pad as claimed in claim 8, wherein each second heat dissipation fin has free end parallel to the main plate after being bent.

15. The brake pad as claimed in claim 9, wherein each second heat dissipation fin has free end parallel to the main plate after being bent.

16. The brake pad as claimed in claim 10, wherein each second heat dissipation fin has free end parallel to the main plate after being bent.

17. The brake pad as claimed in claim 11, wherein the guard has a continually wave-shaped cross-section.

18. The brake pad as claimed in claim 12, wherein the guard has a continually wave-shaped cross-section.
